(19) United States
(12) Patent Application Publication
(10) Pub. No.: US 2018/0304594 A1
(43) Pub. Date: Oct. 25, 2018

(54) THERMOFORMABLE SHRINK FILM AND METHOD FOR PRODUCTION THEREOF

(71) Applicant: MARIA SOELL HIGH TECHNOLOGY FILMS GMBH, 63667 Nidda-Eichelsdorf (DE)

(72) Inventor: MATTHIAS JOHANNSEN, 63667 Nidda-Eichelsdorf (DE)

(73) Assignee: MARIA SOELL HIGH TECHNOLOGY FILMS GMBH, 63667 Nidda-Eichelsdorf (DE)

(21) Appl. No.: 15/757,340

(22) PCT Filed: Jul. 29, 2016
(86) PCT No.: PCT/EP2016/068204

§ 371 Date: Jun. 11, 2018

(30) Foreign Application Priority Data
Sep. 3, 2015 (DE) 10 2015 114 782.3

(51) Int. Cl. B32B 27/08; B32B 27/30; B32B 27/32; B32B 27/34; B32B 7/02; B32B 7/12; B29C 49/00; B29C 49/04; B29C 49/08

(52) U.S. Cl. CPC B32B 27/08; B29C 2049/0089; B32B 27/308; B32B 27/32; B32B 27/34; B32B 7/02; B32B 7/12; B29C 49/0073; B29C 49/04; B29C 49/08; B32B 2250/05; B32B 2250/24; B32B 2270/00; B32B 2307/518; B32B 2307/7244; B32B 2307/7246; B32B 2307/736; B32B 2323/04; B32B 2329/04; B32B 2377/00; B32B 2439/70; B32B 27/306

(57) ABSTRACT

A deep-drawable and heat-shrinkable film based on a coextruded multi-layer film is provided having improved deep drawability and good oxygen and water vapour barrier properties. The multi-layer film is made up of at least nine layers which, from outer to inner layer, have the following structure: 60-40 vol % polyamide (PA), 40-60 vol % amorphous polyamide (aPA)//100 vol % adhesion-promoting agent//100 vol % partially neutralised ethylene (meth)acrylic acid copolymer (ionomer)//100 vol % adhesion-promoting agent//60-40 vol % polyamide (PA), 40-60 vol % amorphous polyamide (aPA)//100 vol % ethylene vinyl alcohol copolymer (EVOH)//60-40 vol % polyamide (PA), 40-60 vol % amorphous polyamide (aPA)//100 vol % adhesion-promoting agent//70-40 vol % low density polyethylene (LDPE), 30-60 vol % linear low density polyethylene (LLDPE). The films are produced on a blown-film extrusion line with three bubbles.

The present invention relates to a deep-drawable shrink film based on a coextruded multi-layer film with good oxygen and water vapour barrier properties, which is particularly suitable for the packaging of fresh poultry and meat or cold cuts.

Most polymer-based food packaging made available today for end customers belongs to either of the two groups of deep-drawn or vacuum shrink packaging. While deep drawn films allow for perfectly skin tight and attractive product packaging and presentation, vacuum shrink processes can guarantee an improved product protection for example due to the extraction of air from the packaging and by preventing product liquids from filling hollow spaces inside the packaging. For some time now, films providing both deep-draw and shrink properties also have used for food packaging.

In this type of packaging, the bottom web deep drawn to form a packaging tray equivalent to the size and form of the food to be wrapped. This tray is then filled with the food product, evacuated and sealed with a top film. After trimming the film to the size of the tray, the product is placed into a dip tank, with hot water filled, so the film retracts exactly to the shape of the product and has no wrinkles nor hollow spaces while wrapping the product tightly and providing optimum seal strength. The food is wrapped by machine, meeting maximum hygiene requirements and ensuring a considerably extended shelf life. Thanks to its high transparency and perfect seal position, the film provides a clear view of the wrapped products.

However, in order to achieve all these targets, films have to be provided with rather contrary properties: during the initial thermoforming process, these films must be able to stretch when heated to form a solid shape. During the subsequent shrinking process, the films must be able to retract in a controlled and uniform way so as to wrap the product smoothly and tight.

For example, WO 2011/083707 A1 relates to a prior art heat-shrinkable multi-layer film on a polyamide basis that also is suitable for deep-draw forming. The main design feature of the proposed three-layer film is an intermediate layer comprising a mixture of an aliphatic polyamide having a melting point of at least 180° C., and an amorphous aromatic polyamide, with a thickness between 25% and 50% of the overall thickness of the film. This structure can also be complemented with a barrier layer or an EVOH basis as desired, applied on an adhesion-promoting layer onto either side of the polyamide layer.

Both the intended higher melting point and the high content of polyamide layers in the film are designed to improve the deep drawability of the film. Moreover, the elevated melting point is deemed essential for the manufacturing process as no film can be produced below 180° C. In addition, one of the parameters defined for good deep-draw properties of the film suggests that its tensile stress at 100° C. and an elongation of 100% shall be between 3 and 22 N.

With a thickness ratio of the polyamide layer below the lower limit of 25% of the total thickness, the application describes considerable unevenness in the thickness at the time of stretching the film during the manufacturing process and difficulties in acquiring a good deep drawability.

However, similar problems also occur when the films are deep drawn. Despite their improved deep drawability, the disclosed films still show the problem of thickness fluctuations in the stretched material and thin areas in the corners and at the edges of the mould particularly when deep drawn into relatively deep moulds, which would require a good and especially smooth stretchability.

Moreover, the disclosed films show a higher stretchability in machine direction, which makes them appropriate for the packaging of elongated products that are shrink-wrapped in transverse direction. Particularly in the case of larger sausages or elongated meat parts, wrapping in machine direction often seems the better choice as it allows larger variations in the packaging length.

Based on the state of the art, the task of the present invention was to provide a deep drawable and heat shrinkable film characterized by improved deep-drawing properties while oxygen and water vapour barrier properties that are relevant for the packaging and puncture resistance are supposed to remain at a very high level. Improved deep-drawing properties are supposed to manifest themselves particularly in a smooth stretching of the film during the thermoforming process and reduced thin areas. Another aspect of the invention relates to the special application of the film to the packaging of elongated products in machine direction.

This task is accomplished by a deep-drawable and heat-shrinkable multi-layer film made up of at least nine layers, with layers (from outer to inner) having the following structure:
(1) 60-40 vol % polyamide (PA), 40-60 vol % amorphous polyamide (aPA)
(2) 100 vol % adhesion-promoting agent
(3) 100 vol % partially neutralised ethylene (meth)acrylic acid copolymer (ionomer)
(4) 100 vol % adhesion-promoting agent
(5) 60-40 vol % polyamide (PA), 40-60 vol % amorphous polyamide (aPA)
(6) 100 vol % ethylene vinyl alcohol copolymer (EVOH)
(7) 60-40 vol % polyamide (PA), 40-60 vol % amorphous polyamide (aPA)
(8) 100 vol % adhesion-promoting agent
(9) 70-40 vol % low density polyethylene (LDPE), 30-60 vol % linear low-density polyethylene (LLDPE)

According to this structure, the thickness of the ionomer layer (3) is greater than the sum of the PA/aPA blend layers (5) and (7). Each of the adhesion-promoting layers (4) and (8) account for at least 5% of the total thickness of the film.

In order to achieve an improved deep drawability, it has proved essential for the ionomer layer to be thicker than both PA/aPA blend layers that enclose the EVOH layer. It is only due to this high ionomer content that the film stretches uniformly on deep-drawing despite a high stretchability of the film. With lower ionomer contents the film tends to show thin areas at edges and in corners, which can lead to leakages in the finished packaging. The ionomer layer preferably is even thicker than those three layers taken together.

Furthermore, it is essential for the deep-draw and barrier properties of the finished film and its behaviour in processing that no layer is completely made up of semi-crystalline polyamide but of a semi-crystalline polyamide/amorphous polyamide blend. In the claimed film formulation, an outer layer consisting entirely of aliphatic polyamide would provoke stretch marks on deep drawing, while the PA/aPA blend according to the invention does not lead to stretch marks nor “spider veins” in the polyester outer layer in areas that more intensely deep-drawn.

The LDPE/LLDPE ratio of the seal layer (9) shall be determined according to the sealing properties required while retaining the claimed range. However, processing conditions in the thermoforming machine are the limiting factor of this ratio as it has to be made sure that the seal layer does not melt under those conditions.

Preferably, the thicknesses of the layers (1) to (9) in relation to the total thickness of the film represent the following values:

| Layer | (1) | (2) | (3) | (4) | (5) | (6) | (7) | (8) | (9) |
|---|---|---|---|---|---|---|---|---|---|
| Thickness | 2-5 | 4-6 | 19-27 | 5-7 | 5-10 | 8-10 | 5-10 | 5-7 | 30-40 |
| [%] | | | | | | | | | |

The thickness of either of the adhesion-promoting layers (4) and (8), which enclose the PA/EVOH/PA barrier block, preferably are 5-7%, particularly preferably 6-7% of the total thickness to guarantee that their thickness is sufficient even when the film is deep drawn so that stretch marks and delamination can be prevented.

The multilayer film according to the invention preferably is biaxially stretched and thermofixed in a way that its shrinkage S will be 10% S 20% both in machine (MD) and transverse direction (TD) when placed for 5 secs in a water bath at 90° C.

The adhesion-promoting agent preferably is a maleic anhydride-grafted LLDPE.

The amorphous polyamide preferably is a polyamide 6I/6T (polyamide obtained by polymerising hexamethylenediamine/isophthalic acid and hexamethylenediamine/terephthalic acid).

Moreover, an advantageous variant of the invention would be a PA 6, PA 66 or PA 6/66 used in the inner layers (5) and (7) and a PA 6/66 used in the outer layer (1).

The production of the deep-drawable and heat-shrinkable multilayer film according to the invention is realised in a blown-film coextrusion process with a biaxial orientation and thermofixation in three bubbles according to the invention, comprising the following steps:
a. Coextrusion of a film with a structure according to the invention and a composition according to the invention in a first bubble to form a tubular product;
b. Cooling and flattening of the tubular product to a temperature below 30° C. with water of a temperature of 10-20° C.;
c. Reheating of the lay-flat tube in a water bath at a temperature of 85-98° C.;
d. Blowing-up and stretching of the reheated tube to a second bubble with a blowing ratio of 2.1 to 2.7 and a longitudinal stretch ratio of 2.1 to 2.6;
e. Blowing-up of the tube to achieve a third bubble for thermofixation by reheating the film to reach a surface temperature of 70-85° C. and relaxation of the film in transverse direction by 15-30% and in longitudinal direction by 10-20%.

The temperature of the water bath in step c. particularly preferably is 90-95° C.

The blow-up ratio particularly preferably is 2.2 to 2.6 and the longitudinal stretch ratio 2.2 to 2.5.

The relaxation percentage of the film in step e. particularly preferably is 20-25% in transverse direction and 13-16% in longitudinal direction.

### EXAMPLES

The films given as examples were manufactured using the following raw materials:

### Adhesion—

promoting agent: As an adhesion-promoting agent, Admer® NF911, was used, a maleic anhydride-grafted LLDPE, manufactured by Mitsui and showing an MFI of 2.5 g/10 min (190° C./2.16 kg) and a density of 0.9 g/cm³.
Ionomer: The ionomer used is Surlyn® 1601 manufactured by DuPont® de Nemour. It exhibits a density of 0.94 g/cm³ and an MFI of 1.3 g/10 min (190° C./2.16 kg).
PA 6: As a PA component of the inner layers, a polyamide 6 marketed under the name of Ultramid® B4OL with a density of 1.12-1.15 g/cm³ (measured according to ISO 1183) and a relative viscosity of 3.89-4.17 (1% in 96% sulphuric acid, measured according to ISO 307, calculated according to Huggins) manufactured by BASF SE was used. Its melting point is 220° C. (measured according to ISO 3146).
PA 6/66: As PA component of the outer layer a polyamide 6/66 manufactured by BASF SE marketed under the name of Ultramid® C40L was used. It exhibits a density of 1.12 g/cm³ (measured according to ISO 1183), a relative viscosity of 3.89-4.17 (1% in 96% sulphuric acid, measured according to ISO 307, calculated according to Huggins). Its melting point is 193° C. (measured according to ISO 3146).
aPA: The amorphous polyamide is a polyamide 6I/6T (polyamide obtained by polymerising hexamethylenediamine/isophthalic acid and hexamethylenediamine/terephthalic acid) type Grivory® 21 manufactured by EMS-Chemie AG with a density of 1.18 g/cm³ and an MVR of 21.1 ml/10 min (275° C./5 kg).
EVOH: The ethylene vinyl alcohol copolymer Soarnol™ AT4403 manufactured by Nippon Gohsei Europe GmbH exhibits an ethylene percentage of 44%, an MFI of 3.5 g/10 min (190° C./2.16 kg) and a density of 1.14 g/cm³.
LDPE: The LDPE component applied was high pressure polyethylene Lupolen® 2420 H manufactured by LyondellBasell Industries with a density of 0.924 g/cm³ and an MFI of 1.9 g/10 min (190° C./2.16 kg).
LLDPE: The LLDPE applied was metallocene catalysed polyolefin plastomer (POP) Affinity™ PL1880G manufactured by Dow Chemicals with a density of 0.902 g/cm³ and an MFI of 1.0 g/10 min (190° C./2.16 kg).

The films were manufactured in a blown-film coextrusion process with three bubbles. The primary tube produced in the first bubble was quenched with water at 14° C. to achieve a temperature of approx. 25° C. The primary tube was then reheated in a water bath at 95° C. and blown a second time. The blow-up ratio of the second bubble was 2.4 while its longitudinal stretching ratio amounted to 2.3. Through thermofixation in the third bubble, a relaxation of the film of 14% in longitudinal direction and 25% in transverse direction was achieved at a thermofixing temperature of the film surface of approx. 77° C.

The films were produced on an 11-layer line. Therefore, either of the (functional) layers (3) and (9) consists of two identical layers a and be, as is shown in the table below.

### Example No. 1

The total thickness of the film manufactured is 60 μm.

| | Thickness | | |
|---|---|---|---|
| Layer | [μm] | [%] | Composition |
| (1) | 1.8 | 3 | 60 vol % PA 6/66 + 40 vol % aPA |
| (2) | 3.0 | 5 | adhesion-promoting agent |
| (3) a + b | 10.8 + 3.0 | 18 + 5 | ionomer |
| (4) | 3.6 | 6 | adhesion-promoting agent |
| (5) | 3.0 | 5 | 60 vol % PA 6 + 40 vol % aPA |
| (6) | 6.0 | 10 | EVOH |
| (7) | 3.0 | 5 | 60 Vol. % - PA 6 + 40 vol % aPA |
| (8) | 3.6 | 6 | adhesion-promoting agent |
| (9) a + b | 6.0 + 16.2 | 10 + 27 | 70 vol % LDPE + 30 vol % LLDPE |
| | | | (mPE) |
| total | 60 | 100 | |

### Example No. 2

The total thickness of the film manufactured is 90 μm.

| | Thickness | | |
|---|---|---|---|
| Layer | [μm] | [%] | Composition |
| (1) | 2.7 | 3 | 60 vol % PA 6/66 + 40 vol % aPA |
| (2) | 4.5 | 5 | adhesion-promoting agent |
| (3) a + b | 18.0 + 4.5 | 20 + 5 | ionomer |
| (4) | 5.4 | 6 | adhesion-promoting agent |
| (5) | 4.5 | 5 | 60 vol % PA 6 + 40 vol % aPA |
| (6) | 7.2 | 8 | EVOH |
| (7) | 4.5 | 5 | 60 vol % - PA 6 + 40 vol % aPA |
| (8) | 5.4 | 6 | adhesion-promoting agent |
| (9) a + b | 9.0 + 24.3 | 10 + 27 | 70 vol % LDPE + 30 vol % LLDPE |
| | | | (mPE) |
| total | 90 | 100 | |

As a prior art comparative example, a deep-drawable shrink film type Krehalon FS90-M No. 9 manufactured by Krehalon Industries B. V. with a thickness of 90 μm and high-barrier properties was used.

Measuring Methods

The degree of shrinkage in machine direction (MD) and transverse direction (TD) was determined by immersing a film sample measuring 100 mm×100 mm into a water bath at a temperature of 90° C. following DIN EN ISO 11501.

Stress-strain measurements were realised according to DIN EN ISO 527-3 in a standard atmosphere at 23° C. and 50% relative humidity.

Puncture resistance was determined according to DIN 53373 in a standard atmosphere at 23° C. and 50% relative humidity.

Oxygen permeability was measured according to DIN 53380-3 at 23° C. and 0% relative humidity.

Water vapour transmission was measured according to DIN EN ISO 15106-2 at 23° C. and 85% relative humidity.

The table below shows the properties of the films according to the invention as compared to the comparative example.

| | | | | Comparative |
|---|---|---|---|---|
| | | Example no. 1 | Example no. 2 | example |
| Tensile strength | MD | 51.5 | 49.0 | 41.6 |
| [N/mm²] | TD | 33.3 | 37.0 | 45.1 |
| Elongation at break | | 135 | 122 | 180 |
| [%] | TD | 148 | 185 | 121 |
| Shrinkage | MD | 14 | 16 | 10 |
| [%] | TD | 12 | 12 | 19 |

| | | | |
|---|---|---|---|
| Puncture resistance [N] | 9.2 | 16.3 | 12.0 |
| Oxygen permeability | 6.6 | 4.2 | 11.0 |
| [cm³/(m² · d · bar)] | | | |
| Vapour transmission | 2.4 | 1.4 | 4.0 |
| [g/(m² · d)] | | | |

A direct comparison of example no. 2 and the comparative example of the same thickness shows that the elongation at break of the film according to the invention is on the same level while it stretches more in transverse direction than in machine direction. As a consequence, this film makes it easier be easier to wrap an elongated product that is to be packed in machine direction.

Values for puncture resistance, which are essential for the packaging of e.g. bone-in meat, are approx. 25% higher. Barrier properties are very good and excel the comparative film by 60-65%. On the other hand, tensile strength in transverse direction is approx. 10% lower compared to the machine direction of the comparative film while it is approx. 10% higher in machine direction than the transverse direction of the comparative film. However, the fact that the lowest absolute value for the tensile strength is slightly below the value for the comparative film is insignificant if compared to the invention's higher values for puncture resistance, as the packaging is more likely to suffer perforation from the inside due to bones or other pointed or sharp-edged parts of the products to be wrapped than to be subject to tensile forces during the manufacturing process of the film or on the filled packaging.

Deep Drawing Tests

The practical suitability for deep drawing was tested on films of example no. 2 and the comparative example, both with a thickness of 90 μm, by manufacturing a deep-drawn tray. To this effect, tests were run on a production line manufactured by Seal-pac GmbH. Films were deep drawn at a thermoforming temperature of 115° C.

The table below shows the evaluation of the comparison of the thin areas of a deep-drawn tray measuring 440 mm×300 mm×140 mm (L×W×D). The four thinnest areas of either example were measured.

| Measuring point | Example no. 2 | Comparative example |
|---|---|---|
| 1 | 34.5 μm | 31.0 μm |
| 2 | 34.5 μm | 29.0 μm |
| 3 | 34.5 μm | 31.5 μm |
| 4 | 37.0 μm | 28.0 μm |
| Average value | 35.1 μm | 29.9 μm |

A second test consisted in deep drawing another tray in a deep drawing mould measuring 440 mm×220 mm×140 mm (L×W×D) and the average thickness of the thin areas was calculated. As a result, the thin areas in example no. 2 showed a slightly greater thickness of 33 μm compared to 30 μm in the comparative example.

Both tests show that the film according to the invention exhibits a more uniform thickness after deep drawing. The overall thickness of the thin areas is greater while their dispersion is lower than in the comparative example. This has a positive impact on the tightness and durability of the packaging as perforations are especially likely to occur in these critical areas.

What is claimed is:

1. A deep-drawable and heat-shrinkable multi-layer film made up of at least nine layers, said at least nine layers, from outward to inward, having the following respective compositions:
(1) 60-40 vol % polyamide (PA), 40-60 vol % amorphous polyamide (aPA)
(2) 100 vol % adhesion-promoting agent
(3) 100 vol % partially neutralised ethylene (meth)acrylic acid copolymer (ionomer)
(4) 100 vol % adhesion-promoting agent
(5) 60-40 vol % polyamide (PA), 40-60 vol % amorphous polyamide (aPA)
(6) 100 vol % ethylene vinyl alcohol copolymer (EVOH)
(7) 60-40 vol % polyamide (PA), 40-60 vol % amorphous polyamide (aPA)
(8) 100 vol % adhesion-promoting agent
(9) 70-40 vol % low density polyethylene (LDPE), 30-60 vol % linear low-density polyethylene (LLDPE),
wherein a thickness of the ionomer layer (3) is greater than a sum of the PA/aPA blend layers (5) and (7), and wherein each of the adhesion-promoting layers (4) and (8) account for at least 5% of a total thickness of the multi-layer film.

2. The deep-drawable and heat-shrinkable multi-layer film of claim 1, wherein the thicknesses of the layers (1) to (9) in relation to the total thickness of the multi-layer film present the following values:

| Layer | (1) | (2) | (3) | (4) | (5) | (6) | (7) | (8) | (9) |
|---|---|---|---|---|---|---|---|---|---|
| Thickness | 2-5 | 4-6 | 19-27 | 5-7 | 5-10 | 8-10 | 5-10 | 5-7 | 30-40 |
| [%] | | | | | | | | | |

3. The deep-drawable and heat-shrinkable multi-layer film of claim 1, said multi-layer film being biaxially stretched and thermofixed in a way that at a residence time of the multi-layer film of 5 seconds in a water bath at 90° C. a shrinkage S of the multi-layer film both in a machine direction (MD) and in a transverse direction (TD) is equivalent to 10%≤S≤20%.

4. The deep-drawable and heat-shrinkable multi-layer film of claim 1, wherein the adhesion-promoting agent is a maleic anhydride-grafted LLDPE.

5. The deep-drawable and heat-shrinkable multi-layer film of claim 1, wherein the amorphous polyamide is a polyamide 6I/6T (polyamide obtained by polymerising hexamethylenediamine/isophthalic acid and hexamethylenediamine/terephthalic acid).

6. The deep-drawable and heat-shrinkable multi-layer film of claim 1, wherein the polyamide used in the inner layers (5) and (7) is one of a PA 6, PA 66 and PA 6/66 and the polyamide used in the outer layer (1) is a PA 6/66.

7. A process for manufacturing a deep-drawable and heat-shrinkable multi-layer film in a blown-film coextrusion process with a biaxial orientation and thermofixation in three bubbles, said process comprising the steps of:
Coextrusion of the multi-layer film according to claim 1 in a first bubble to form a tubular product;
Cooling and flattening of the tubular product to a temperature below 30° C. with water of a temperature of 10-20° C.;
Reheating of the lay-flat tube in a water bath at a temperature of 85-98° C.;
Blowing-up and stretching of the reheated tube to a second bubble with a blowing ratio of 2.1 to 2.7 and a longitudinal stretch ratio of 2.1 to 2.6; and
Blowing-up of the tube to achieve a third bubble for thermofixation by reheating the film to achieve a surface temperature of 70-85° C. and relaxation of the film in transverse direction by 15-30% and in longitudinal direction by 10 20%.
